(19) United States
(12) Patent Application Publication
(10) Pub. No.: US 2007/0018465 A1
(43) Pub. Date: Jan. 25, 2007

(54) Appliance door safety system

(76) Inventors: Mary Vassilakos, Holmdel, NJ (US); Constantine Vassilakos, Holmdel, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/453,635

(22) Filed: Jun. 15, 2006

Related U.S. Application Data
(60) Provisional application No. 60/691,038, filed on Jun. 16, 2005.

(51) Int. Cl. E05C 3/06

(52) U.S. Cl. 292/216; 482/129

(57) ABSTRACT

An appliance door safety system for securing the door of an appliance closed. The system includes a strap or other length of material having a fastening device at each end thereof and a strap securing device. Also disclosed is a strap securing device having a bracket having a means for engaging a fastening device of said strap.

### CROSS REFERENCE TO RELATED APPLICATIONS

This application claims the benefit of U.S. Provisional Patent Application No: 60/691,038, filed Jun. 16, 2005, entitled “Appliance Door Safety System,” the entire disclosure of which is hereby incorporated by reference.

### BACKGROUND OF THE INVENTION

The present invention relates to safety devices and in particular to a strap system for preventing a child from opening an appliance door such as an oven door.

Kitchen appliances, such as kitchen ranges, pose safety hazards, especially for young children. Due to their low height, oven doors of kitchen ranges present a potential hazard for children, particularly burn-type injuries or injuries sustained as a result of children attempting to crawl into the oven. There have been many instances of children burning their hands simply by resting their hands on a hot open oven door.

Commercially available latch type devices that are adhered to the side of the oven and oven door are ineffective against a persistent toddler, as the adhesive bond is insufficient to defeat repeated tugs. Moreover the heat effect of the oven on the adhesive employed for such latches can degrade the adhesive bond.

Moreover, not all ranges, in fact very few, are equipped with a door lock feature.

Thus there exists a need in the art for a device that secures an oven door of a range in a closed position either during use or when the oven is not in use.

### SUMMARY OF THE INVENTION

An appliance door safety system is provided for securing the door of an appliance closed. In one embodiment, the system includes a strap or other length of material having a fastening device at each end thereof and a strap securing device.

In another embodiment a strap securing device is provided comprising a bracket having a means for engaging a fastening device of said strap.

### DESCRIPTION OF THE DRAWINGS

FIG. 1 depicts components of a system in accordance with one embodiment of the present invention.

FIG. 2 depicts a front elevational view of one embodiment of the system in accordance with the present invention.

FIG. 3 depicts a perspective view of an embodiment of a strap securing device in accordance with the present invention.

FIG. 3A depicts a top plan view of an embodiment of a detail of the strap securing device of FIG. 3 in accordance with the present invention.

FIG. 4 depicts a perspective view of an embodiment of a strap securing device in accordance with the present invention.

FIG. 5 is a side view of an embodiment of the system in accordance with the present invention.

FIG. 6 is a side view of an embodiment of the system in accordance with the present invention.

### DETAILED DESCRIPTION OF THE PREFERRED EMBODIMENTS

In the following description for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature structure or characteristic described in connection with the embodiment is included in at least one embodiment of the invention. The appearances of phrases such as “in one embodiment” in various places in the specification are not necessarily all referring to the same embodiment.

A safety strap system for an oven door is provided to prevent children from opening an oven door.

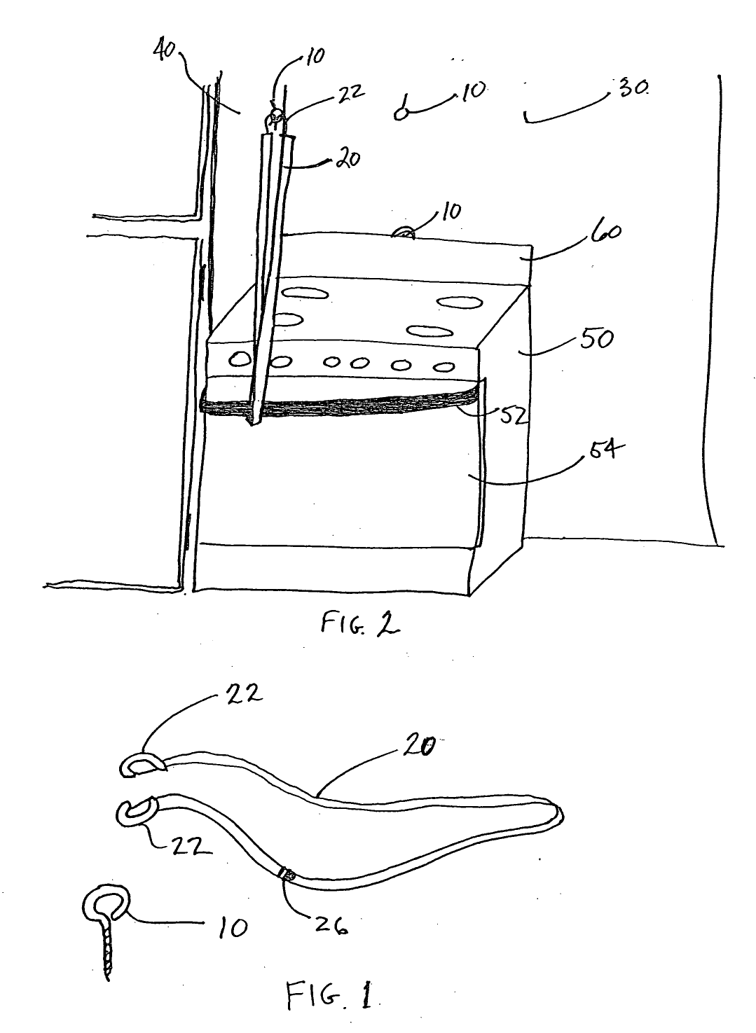

Now referring to FIG. 1 in one embodiment a system for securing a door of an oven in a closed position is disclosed comprising strap 20 having fastening devices 22 extending from ends thereof and a strap securing device 10.

Strap 20 comprises any suitable strap material such as canvas, rubber, rope or the like. Fastening device 22 comprises any suitable fastener device such as but not limited to a hook, latch, carabiner or clasp. Strap securing device 10 comprises any device that includes complementary fastening means for fastening device 22, such as but not limited to a hook, eyebolt, carabiner, complementary latch device or complementary clasp device. Strap securing device 20 is made of any suitable material including but not limited to metal, wood, plastic, rubber, fabric or the like.

Strap 20 may be provided with an adjustment device 26 of examples of which are well known to those having ordinary skill in the art to permit adjustment of the length of the strap 20.

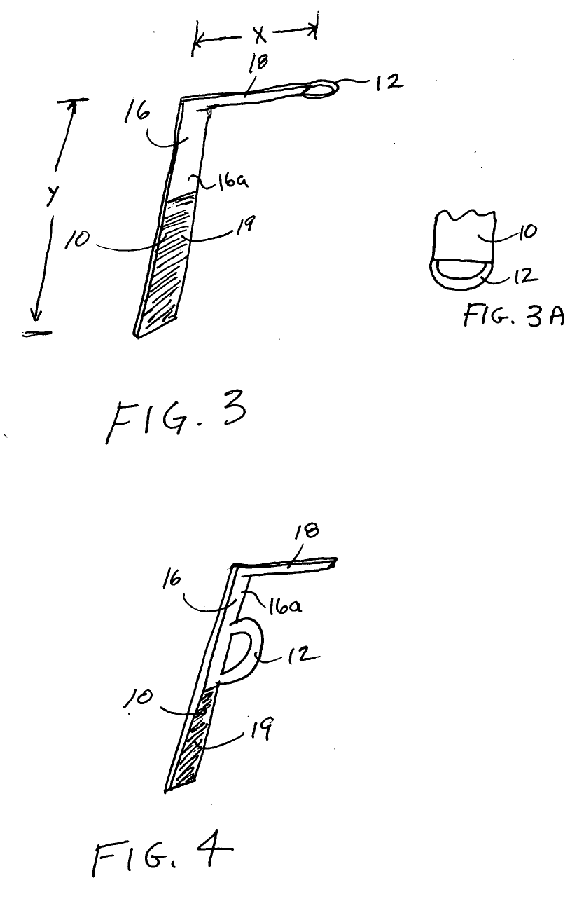

Now referring to FIG. 2, in an embodiment securing device 10 is fastened to a wall 30, cabinet 40, or top portion 60 of an oven 50. Strap 20 is looped around handle 52 of oven 50 and fastening devices 22 are fastened to strap securing device 10. The length of strap 20 may be adjusted to provide a tight closure of door 54. In this way door 54 is secured and the fastening devices are not reachable by a child.

Now referring to FIG. 3, in an alternative embodiment strap securing device 10 includes a substantially L-shaped bracket having vertical element 16 and horizontal element 18 and attachment means 12 extending from an end of horizontal portion 18. Optionally, the device 10 in accordance with this embodiment may include a friction enhancing coating or surface 19 disposed thereon. In one embodiment as shown in FIG. 3 vertical portion 16a comprises a friction enhancing surface 19 in region 16A. It will be apparent to those having skill in the art any portion of strap securing device 10 may comprise a friction enhancing surface 19. Friction enhancing surface 19 may comprise a coating of rubber, a roughened surface or any other suitable friction enhancing surface as is known to those having skill in the art. Strap securing device 10 may be formed of an entirely friction enhancing surface. Alternatively, friction enhancing surface 19 may be a light adhesive, the amount of adhesive disposed on surface 16A being insufficient to provide secure attachment of surface 16A to an appliance absent a pulling force exerted by strap 20.

Now referring to FIG. 3A, a loop 12 is provided for receiving and engaging a fastening device 22.

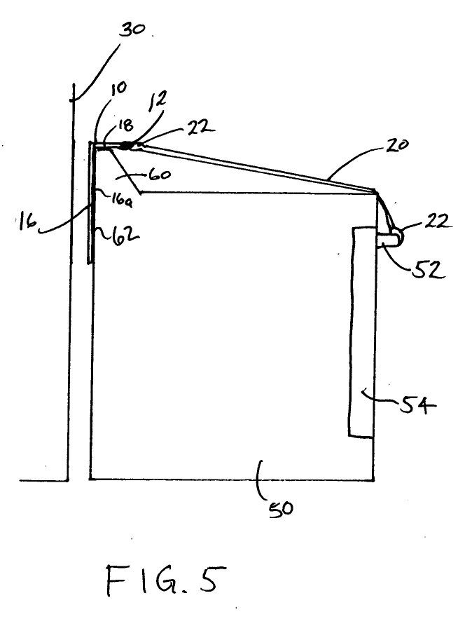

Now referring to FIG. 4, an L-shaped bracket such as described in FIG. 3 is disclosed. In accordance with this embodiment, a loop 12 is provided for receiving a fastening device 22.

L-shaped strap securing device 10, in accordance with FIGS. 3 and 4 is adapted to fit and engage a rear of a top portion 60 of an oven, particularly a range type oven. Surface 16A is adapted to fit in close contact with rear 62 of oven 50 and horizontal element 18 is adapted to engage in close contact with the top portion 60 of oven 50.

In an embodiment, vertical portion 16 may have a length Y in a range of from about 3 inches to about 36 inches, preferably from about 5 inches to about 15 inches and most preferably between about 6 inches and 12 inches. Horizontal portion 18 may have a length X in the range of from about 1 inch to about 6 inches and most preferably about 2 inches.

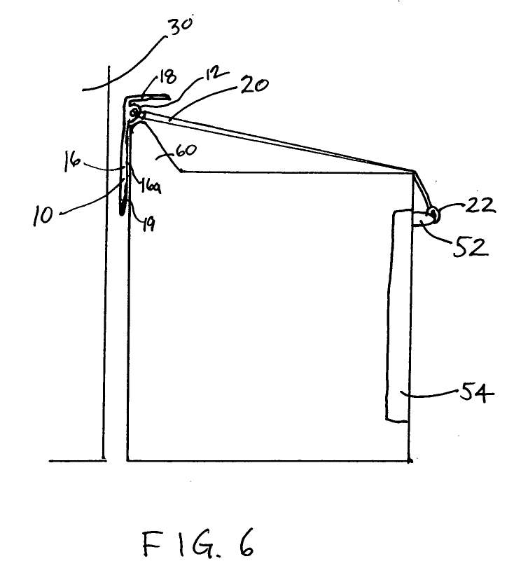

Now referring to FIG. 5, strap securing device 10 is shown in accordance with an embodiment of the present invention. Strap securing device 10 is oriented as described hereinabove in close contact with the back 62 and top 60 of an oven. Fastening device 22 extending from strap 20 is engaged to loop 12 at one end and fastening device 22 is engaged to handle 52 of oven at the other end of strap 20. Alternatively, strap 20 may be looped around a handle 52 of an oven as in FIG. 2 and fastening devices 22 both fastened to strap securing device 10. By a tensioning force, the safety strap system of the present invention prevents the door 54 of oven 50 from being opened. When an opening force is applied to oven door 54, strap securing device 10 is urged toward the back surface 62 of range 50. In the embodiment of FIG. 5 employing strap securing device 10 having the structure as shown in FIG. 3, vertical portion 16 is of sufficient length to, if it were to tilt away from surface 62 in response to tension on strap 20, to abut wall 30. Likewise, in accordance with the embodiment depicted in FIG. 6, the vertical portion 16 will abut the wall 30 if strap 20 pulls loop 12 such that close contact of vertical portion 16 is disrupted. In addition, in such an event, horizontal portion 18 of strap securing device 10 will act as a stop.

In an alternate embodiment, not shown, vertical portion 16 extends the entire height of said range.

In a preferred embodiment, the strap securing device is oriented to the extreme left or right of the burners atop of oven 50 when such oven is in the form of a range having range top burners, so that the range top burners may be used even while the safety strap system of the present invention is in place.

It will be apparent to a skilled artisan the system may be employed to secure the closure of the door(s) of a refrigerator, freezer, microwave oven or the like.

While the preferred embodiments have been described and illustrated it will be understood that changes in details and obvious undisclosed variations might be made without departing from the spirit and principle of the invention and therefore the scope of the invention is not to be construed as limited to the preferred embodiment.

What is claimed is:

1. A door closure system comprising a strap having at least one fastening device extending from an end thereof and at least one strap securing device adapted to securably attach to an appliance.

2. The system in accordance with claim 1, said strap comprising two ends and having a fastening device extending from each end, at least one of said fastening devices adapted to securably engage a handle of a door of an appliance.

3. The system in accordance with claim 1 at least one of said fastening devices selected from the group comprising a hook, latch, carabiner and clasp.

4. The system in accordance with claim 1 the strap securing device comprising at least one fastening means complementary to said fastening device 22.

5. The system in accordance with claim 4 said at least one strap securing device selected from the group comprising a hook, eyebolt, carabiner, latch and clasp.

6. The system in accordance with claim 1 said strap securing device selected from the group comprising metal, wood, plastic, rubber and fabric.

7. The system in accordance with claim 1 said strap comprising a length-adjustment device.

8. The system in accordance with claim 1 said strap securing device comprising an L-shaped member and an attachment means disposed thereon for receiving said at least one fastening device.

9. The system in accordance with claim 8 said L-shaped member having a vertical portion and a horizontal portion and attachment means extending from an end of said horizontal portion.

10. The system in accordance with claim 8, either or both of said vertical or horizontal portions comprising a friction enhancing surface.

11. The system in accordance with claim 9, said strap securing device comprising a friction enhancing surface.

12. The system in accordance with claim 8 having a vertical portion having a length in a range of from about 3 inches to about 36 inches.

13. The system in accordance with claim 8 having a vertical portion having a length in a range of from about 5 inches to about 15 inches.

14. The system in accordance with claim 8 having a horizontal portion having a length in a range of from about 1 inch to about 6 inches.

15. The system in accordance with claim 8 having a horizontal portion having a length of about 2 inches.

16. A door closure system comprising a strap having at least one fastening device extending from an end thereof and a strap securing device adapted to securably attach to a handle of a door of an appliance, said strap securing device adapted to fit in close contact with a back and top of an appliance, said at least one fastening device at an end of said strap engagable to said strap securing device at one end and a further fastening device is engagable to a handle of an appliance at an other end of said strap, wherein by a tensioning force, the system prevents the door of said appliance from being opened.
